(19) United States
(12) Patent Application Publication
(10) Pub. No.: US 2018/0162350 A1
(43) Pub. Date: Jun. 14, 2018

(54) METHOD AND APPARATUS FOR CONTROLLING MHSG OF MILD HYBRID ELECTRIC VEHICLE

(71) Applicants: Hyundai Motor Company, Seoul (KR); Kia Motors Corporation, Seoul (KR)

(72) Inventor: Hyun KIM, Hwaseong-si (KR)

(73) Assignees: Hyundai Motor Company, Seoul (KR); Kia Motors Corporation, Seoul (KR)

(21) Appl. No.: 15/833,810

(22) Filed: Dec. 6, 2017

(30) Foreign Application Priority Data
Dec. 13, 2016 (KR) 10-2016-0169853

(51) Int. Cl. B60W 20/10; B60K 6/26

(52) U.S. Cl. CPC B60W 20/10; B60K 6/26; B60K 2006/268; B60W 2540/10; B60W 2710/083; F02B 37/00; B60W 2510/0628; B60W 2550/12; Y10S 903/906; B60Y 2200/92; B60W 2510/0638

(57) ABSTRACT

A method of controlling a mild hybrid starter & generator (MHSG) of a mild hybrid electric vehicle may include: detecting data for controlling the MHSG; determining a target boost pressure based on the data; comparing a difference value between the target boost pressure and an intake pressure with a predetermined value; determining a target torque of the MHSG when the difference value between the target boost pressure and the intake pressure is equal to or greater than the predetermined value; and controlling the MHSG to generate the target torque of the MHSG.

### CROSS-REFERENCE TO RELATED APPLICATION

The present application claims priority to Korean Patent Application No. 10-2016-0169853 filed on Dec. 13, 2016, the entire contents of which is incorporated herein for all purposes by this reference.

### BACKGROUND OF THE INVENTION

### Field of the Invention

The present invention relates to a method of and an apparatus for controlling an MHSG of a mild hybrid electric vehicle. More particularly, the present invention relates to a method of and an apparatus for controlling an MHSG of a mild hybrid electric vehicle that can improve acceleration feel.

### Description of Related Art

As is generally known in the art, a hybrid electric vehicle utilizes an internal combustion engine and a battery power source together. The hybrid electric vehicle efficiently combines torque of the internal combustion engine and a torque of a motor.

Hybrid electric vehicles may be divided into a hard type and a mild type according to a power sharing ratio between an engine and a motor. In the case of the mild type of hybrid electric vehicle (hereinafter referred to as a mild hybrid electric vehicle), a mild hybrid starter & generator (MHSG) configured to start the engine or generate electricity according to an output of the engine is used instead of an alternator. In the case of the hard type of hybrid electric vehicle, a driving motor configured for generating driving torque is used in addition to an integrated starter & generator (ISG) configured to start the engine or generate electricity.

The MHSG may assist torque of the engine according to running states of the vehicle, and may charge a battery (e.g., a 48 V battery) through regenerative braking. Accordingly, fuel efficiency of the mild hybrid electric vehicle may be improved.

A turbocharger is a device that rotates a turbine using exhaust gas exhausted from an engine and then increases an output of the engine by supplying high-pressure air into the engine by operating the compressor using torque of the turbine. In the case of the turbocharger, when the vehicle is accelerated in an idle state or a low speed state, turbo-lag due to low exhaust pressure may occur. A driver may feel nonlinear acceleration.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of and an apparatus for controlling an MHSG of a mild hybrid electric vehicle having advantages of preventing turbo-lag by use of torque of the MHSG.

A method of controlling a mild hybrid starter & generator (MHSG) of a mild hybrid electric vehicle according to an exemplary embodiment of the present invention may include: detecting data for controlling the MI-ISG; determining a target boost pressure based on the data; comparing a difference value between the target boost pressure and an intake pressure with a predetermined value; determining a target torque of the MHSG when the difference value between the target boost pressure and the intake pressure is equal to or greater than the predetermined value; and controlling the MHSG to generate the target torque of the MHSG.

The target boost pressure may be determined based on a position value of an accelerator pedal, a speed of an engine, an intake amount, and an intake temperature.

The method may further include not generating torque of the MHSG for preventing turbo-lag when the difference value between the target boost pressure and the intake pressure is less than the predetermined value.

The target torque of the MHSG may be determined based on the difference value between the target boost pressure and the intake pressure.

The method may further include comparing the difference value between the target boost pressure and the intake pressure with the predetermined value while generating the target torque of the MHSG; and not generating torque of the MHSG for preventing turbo-lag when the difference value between the target boost pressure and the intake pressure is less than the predetermined value.

An apparatus for controlling a mild hybrid starter & generator (MHSG) of a mild hybrid electric vehicle according to an exemplary embodiment of the present invention may include: a data detector detecting data for controlling the MHSG that starts an engine or generate electricity by an output of the engine; and a controller determines a target boost pressure based on the data, wherein the controller determines a target torque of the MHSG when a difference value between the target boost pressure and an intake pressure is equal to or greater than a predetermined value, and controls the MHSG to generate the target torque of the MHSG.

The controller may determine the target boost pressure based on a position value of an accelerator pedal, a speed of the engine, an intake amount, and an intake temperature.

The controller may not generate torque of the MHSG for preventing turbo-lag when the difference value between the target boost pressure and the intake pressure is less than the predetermined value.

The controller may determine the target torque of the MHSG based on the difference value between the target boost pressure and the intake pressure.

While the target torque of the MHSG is generated, when the difference value between the target boost pressure and the intake pressure is less than the predetermined value, the controller may not generate torque of the MHSG for preventing turbo-lag.

The data detector may include: an accelerator pedal position detector configured for detecting a position value of an accelerator pedal; an engine speed detector configured for detecting a speed of the engine; an intake pressure detector configured for detecting an intake pressure; an intake amount detector configured for detecting an intake amount; and an intake temperature detector configured for detecting an intake temperature.

According to an exemplary embodiment of the present invention, turbo-lag may be prevented by use of torque of the MHSG. Accordingly, acceleration feel of the mild hybrid electric vehicle may be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a mild hybrid electric vehicle according to an exemplary embodiment of the present invention.

FIG. 2 is a schematic diagram of a turbocharger system according to an exemplary embodiment of the present invention.

FIG. 3 is a block diagram illustrating an apparatus for controlling an MHSG of a mild hybrid electric vehicle according to an exemplary embodiment of the present invention.

FIG. 4 is a flowchart illustrating a method for controlling an MHSG of a mild hybrid electric vehicle according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, exemplary embodiments of the present application will be described more fully with reference to the accompanying drawings, in which exemplary embodiments of the invention are shown. However, the present invention is not limited the exemplary embodiments which are described herein, and may be modified in various different ways.

Parts which are not related with the description are omitted for clearly describing the exemplary embodiment of the present invention, and like reference numerals refer to like or similar elements throughout the specification.

Since each component in the drawings is arbitrarily illustrated for easy description, the present invention is not particularly limited to the components illustrated in the drawings.

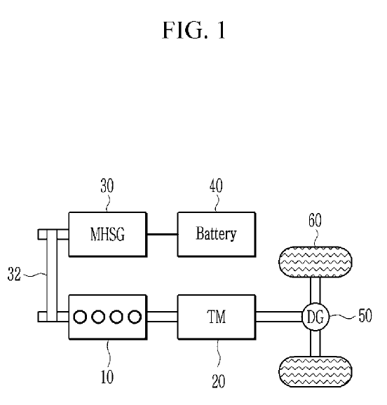

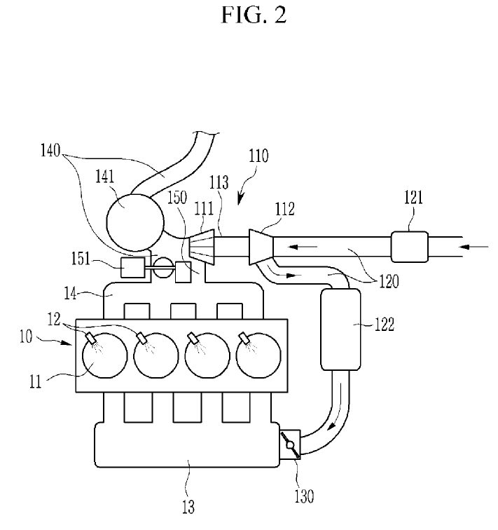

FIG. 1 is a block diagram of a mild hybrid electric vehicle according to an exemplary embodiment of the present invention, and FIG. 2 is a schematic diagram of a turbocharger system according to an exemplary embodiment of the present invention.

As shown in FIG. 1 and FIG. 2, a mild hybrid electric vehicle according to an exemplary embodiment of the present invention includes an engine 10, a transmission 20, a mild hybrid starter & generator (MHSG) 30, a battery 40, a differential gear apparatus 50, and a wheel 60.

The engine 10 burns fuel and air to convert chemical energy into mechanical energy. The engine 10 may include a plurality of combustion chambers 11 into which fuel and air flow and an injector 12 injecting the fuel. The engine 10 is connected to an intake manifold 13 to receive the air in the combustion chamber 11, and exhaust gas generated in a combustion process is gathered in an exhaust manifold 14 and is exhausted to the external of the engine 10.

A turbocharger system according to an exemplary embodiment of the present invention may include a turbocharger 110, an intake line 120, a throttle valve 130, a first exhaust line 140, a second exhaust line 150, and an wastegate valve 151.

The turbocharger 100 includes a turbine 111 and a compressor 112. The turbine 111 rotates by the exhaust gas, and the compressor 112 rotates power occurring by a rotation of the turbine 111. The turbine 111 and the compressor 112 are connected to each through a shaft 113.

The intake line 120 supplies air to the engine 10. The air flowing into the intake line 120 may be purified through the air cleaner 121. While the compressor 112 rotates, air entered from the outside is compressed to be supplied to the engine 10. Therefore, the compressed air is supplied to enhance an output of the engine 10. To cool air that passes through the compressor 22, an intercooler 122 may be mounted on the intake line 120.

Flow of air supplied from the intake line 120 to the engine 10 is controlled according to an opening degree of the throttle valve 130.

The first exhaust line 140 is formed to discharge the exhaust gas of the exhaust manifold 14. A postprocessor 141 including a catalyst may be mounted on the first exhaust line 140 to reduce harmful component of the exhaust gas.

The second exhaust line 150 is formed such that a portion of the exhaust gas joins to the first exhaust line 140 via the turbine 111.

Flow of exhaust gas exhausted from the second exhaust line 150 is controlled according to an opening amount of the wastegate valve 151.

With reference to torque transmission of a mild hybrid electric vehicle, torque generated from the engine 10 is transmitted to an input shaft of the transmission 20, and a torque output from an output shaft of the transmission 20 is transmitted to an axle via the differential gear apparatus 50. The axle rotates the wheel 60 such that the mild hybrid electric vehicle runs by the torque generated from the engine 10.

The MHSG 30 converts electrical energy into mechanical energy or converts mechanical energy into electrical energy. The MHSG 30 starts the engine 10 or generates electricity according to an output of the engine 10. In addition, the MHSG 30 may assist the torque of the engine 10. The torque of the engine 10 may be used as main torque, and a torque of the MHSG 30 may be used as auxiliary torque. The engine 10 and the MHSG 30 may be connected to each other through a belt 32.

The battery 40 may supply electricity to the MHSG 30, and may be charged through electricity recovered by the MHSG 30 in a regenerative braking mode. The battery 40 may be a 48 V battery. The mild hybrid electric vehicle may further include a low voltage battery DC-DC converter (LDC) converting a voltage supplied from the battery 40 into a low voltage, and a low voltage battery (e.g., a 12 V battery) supplying a low voltage to electrical loads (e.g., a head lamp and an air conditioner).

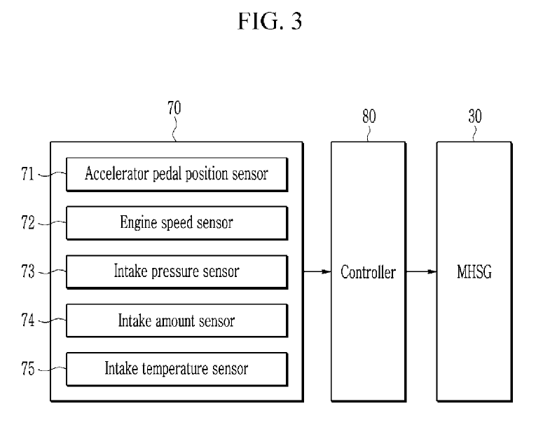

FIG. 3 is a block diagram illustrating an apparatus for controlling an MHSG of a mild hybrid electric vehicle according to an exemplary embodiment of the present invention.

As shown in FIG. 3, an apparatus for controlling an MHSG according to an exemplary embodiment of the present invention includes a data detector 70 and a controller 80.

The data detector 70 detects data for controlling the MHSG 30, and the data detected by the data detector 70 is transmitted to the controller 80. The data detector 70 may include an accelerator pedal position detector 71, an engine speed detector 72, an intake pressure detector 73, an intake amount detector 74, and an intake temperature detector 75. The data detector 70 may further include detectors (e.g., a brake pedal position detector, an SOC detector, and the like) for controlling the mild hybrid electric vehicle.

The accelerator pedal position detector 71 detects a position value of an accelerator pedal (i.e., a pushed degree of an accelerator pedal), and transmits a signal corresponding thereto to the controller 80. When the accelerator pedal is pushed completely, the position value of the accelerator pedal is 100%, and when the accelerator pedal is not pushed, the position value of the accelerator pedal is 0%.

The engine speed detector 72 detects a speed of the engine 10, and transmits a signal corresponding thereto to the controller 80. The engine speed detector 72 may detect the speed of the engine 10 from a phase change of a crankshaft.

The intake pressure detector 73 detects a pressure of air supplied to the engine (intake pressure), and transmits a signal corresponding thereto to the controller 80.

The intake amount detector 74 detects a flow rate of the air supplied to the engine 10 (intake amount), and transmits a signal corresponding thereto to the controller 80.

The intake temperature detector 75 detects a temperature of the air supplied to the engine 10 (intake temperature), and transmits a signal corresponding thereto to the controller 80.

The controller 80 controls the MHSG 30 based on the data detected by the data detector 70. The controller 80 may determine a target boost pressure and may determine a target torque of the MHSG 30 to prevent turbo-lag based on the data. The controller 80 may be implemented with one or more processors executed by a predetermined program, and the predetermined program may include a series of commands for performing each step included in a method for controlling an MHSG of a mild hybrid electric vehicle according to an exemplary embodiment of the present invention.

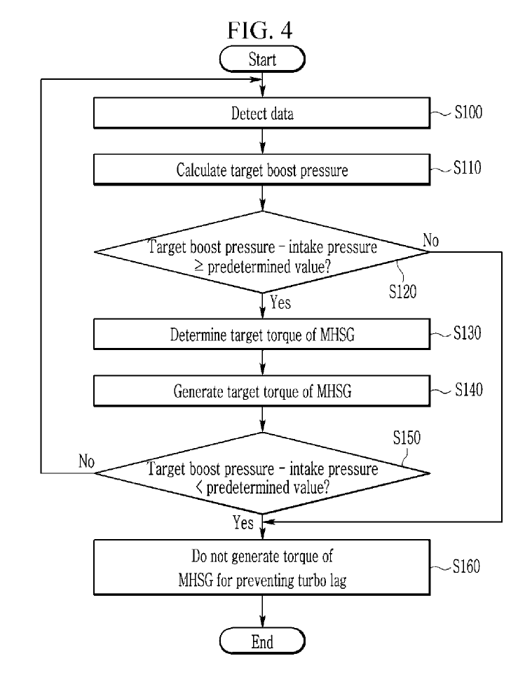

FIG. 4 is a flowchart illustrating a method of controlling an MHSG of a mild hybrid electric vehicle according to an exemplary embodiment of the present invention.

As shown in FIG. 4, a method of controlling an MHSG of a mild hybrid electric vehicle according to an exemplary embodiment of the present invention begins with detecting data for controlling the MHSG 30 at step S100. In other words, the accelerator pedal position detector 71 detects the position value of the accelerator pedal, the engine speed detector 72 detects the speed of the engine 10, the intake pressure detector 73 detects the intake pressure, the intake amount detector 74 detects the intake amount, and the intake temperature detector 75 detects the intake temperature.

The controller 80 determines a target boost pressure TBP based on the data at step S110. For example, the controller 80 may determine the target boost pressure TBP based on the position value of the accelerator pedal, the speed of the engine 10, the intake amount, and the intake temperature.

The controller 80 compares a difference value D1 between the target boost pressure TBP and the intake pressure with a predetermined value P1 at step S120. The predetermined value P1 may be set to a value which is determined by a person of ordinary skill in the art to determine whether the intake pressure follows the target boost pressure TBP. When the intake pressure fails to follow the target boost pressure TBP, turbo-lag may occur.

When the difference value D1 is less than the predetermined value P1 at step S120, since turbo-lag does not occur, the controller 80 may not generate torque of the MHSG 30 for preventing the turbo-lag at step S160.

When the difference value D1 is equal to or greater than the predetermined value P1 at step S120, the controller 80 determines a target torque of the MHSG 30 at step S130. The target torque of the MHSG 30 may be determined based on the difference value D1 between the target boost pressure (TBP) and the intake pressure. In other words, as the difference value D1 is increased, the target torque of the MHSG 30 may be increased to prevent turbo-lag.

The controller 80 may control the MHSG 30 to generate the target torque of the MHSG 30 a step S140. Accordingly, the difference value D1 between the target boost pressure TBP and the intake pressure is decreased, preventing turbo-lag.

While controlling the MHSG 30 to generate the target torque of the MHSG 30, the controller 80 may compare the difference value between the target boost pressure TBP and the intake pressure with a predetermined value P1 at step S150.

When the difference value D1 between the target boost pressure TBP and the intake pressure is equal to or greater than the predetermined value P1 at step S150, the controller 80 continuously performs steps S100 to S140.

When the difference value D1 is less than the predetermined value P1 at step S150, the controller 80 may not generate torque of the MHSG 30 for preventing turbo-lag at step S160.

As described above, according to an exemplary embodiment of the present invention, turbo-lag may be prevented by use of the torque of the MHSG 30. Accordingly, acceleration feel of the mild hybrid electric vehicle may be improved.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of controlling a mild hybrid starter & generator (MHSG) of a mild hybrid electric vehicle, the method comprising:
detecting data for controlling the MHSG;
determining a target boost pressure based on the data;
comparing a difference value between the target boost pressure and an intake pressure of air supplied to an engine with a predetermined value;
determining a target torque of the MHSG when the difference value between the target boost pressure and the intake pressure is equal to or greater than the predetermined value; and
controlling the MHSG to generate the target torque of the MHSG.

2. The method of claim 1, wherein the target boost pressure is determined based on a position value of an accelerator pedal, a speed of the engine, an intake amount of the air, and an intake temperature of the air.

3. The method of claim 1, further including not generating torque of the MHSG for preventing turbo-lag when the difference value between the target boost pressure and the intake pressure is less than the predetermined value.

4. The method of claim 1, wherein the target torque of the MHSG is determined based on the difference value between the target boost pressure and the intake pressure.

5. The method of claim 1, further including:
comparing the difference value between the target boost pressure and the intake pressure with the predetermined value while generating the target torque of the MHSG; and
not generating torque of the MHSG for preventing turbo-lag when the difference value between the target boost pressure and the intake pressure is less than the predetermined value.

6. An apparatus for controlling a mild hybrid starter & generator (MHSG) of a mild hybrid electric vehicle, the system comprising:
a data detector detecting data for controlling the MHSG that starts an engine or generate electricity by an output of the engine; and
a controller configured to determine a target boost pressure based on the data,
wherein the controller is configured to determine a target torque of the MHSG when a difference value between the target boost pressure and an intake pressure of air supplied to the engine is equal to or greater than a predetermined value, and is configured to control the MHSG to generate the target torque of the MHSG.

7. The apparatus of claim 6, wherein the controller is configured to determine the target boost pressure based on a position value of an accelerator pedal, a speed of the engine, an intake amount of the air, and an intake temperature of the air.

8. The apparatus of claim 6, wherein the controller does not generate torque of the MHSG for preventing turbo-lag when the difference value between the target boost pressure and the intake pressure is less than the predetermined value.

9. The apparatus of claim 6, wherein the controller is configured to determine the target torque of the MHSG based on the difference value between the target boost pressure and the intake pressure.

10. The apparatus of claim 6, wherein while the target torque of the MHSG is generated, when the difference value between the target boost pressure and the intake pressure is less than the predetermined value, the controller does not generate torque of the MHSG for preventing turbo-lag.

11. The apparatus of claim 6, wherein the data detector includes:
an accelerator pedal position detector detecting a position value of an accelerator pedal;
an engine speed detector detecting a speed of the engine;
an intake pressure detector detecting the intake pressure;
an intake amount detector detecting an intake amount of the air; and
an intake temperature detector detecting an intake temperature of the air.
